(19) United States
(12) Patent Application Publication
(10) Pub. No.: US 2017/0147995 A1
(43) Pub. Date: May 25, 2017

(54) VEHICLE PARKING SYSTEM, AND METHOD AND DEVICE THEREOF

(71) Applicant: Cellopark Technologies Ltd., Beit Dagan (IL)

(72) Inventor: Natan Kalimi, Givatayim (IL)

(21) Appl. No.: 15/352,616

(22) Filed: Nov. 16, 2016

Related U.S. Application Data
(60) Provisional application No. 62/258,554, filed on Nov. 23, 2015.

(30) Foreign Application Priority Data
Apr. 5, 2016 (IL) 244938

(51) Int. Cl. G06Q 20/10; H04W 4/00; H04W 4/04; H04W 4/14

(52) U.S. Cl. CPC G06Q 20/10; H04W 4/14; H04W 4/008; H04W 4/046; G06Q 2240/00; G06Q 50/30

(57) ABSTRACT

A vehicular parking system includes a parking server, which includes: (a) a wireless transceiver to receive a first wireless signal, indicating that a user of a vehicle that is associated with a smartphone has commenced a paid parking session; (b) a parking session commencement unit that, in response to the first wireless signal, updates a parking record in the vehicular parking system, to indicate that the vehicle is associated with the paid parking session. The wireless transceiver, subsequently, receives a second wireless signal, indicating that the smartphone has autonomously determined to end the paid parking session, based on an autonomous analysis of the smartphone. A parking session termination unit of the server, in response to the second wireless signal, updates the parking record to indicate that the vehicle is no longer associated with any paid parking session.

### CROSS-REFERENCE TO RELATED APPLICATIONS

This patent application claims priority and benefit from U.S. provisional patent application No. 62/258,554, filed on Nov. 23, 2015, which is hereby incorporated by reference in its entirety. This patent application also claims priority and benefit from Israeli patent application number IL 244938, filed on Apr. 5, 2016, which is hereby incorporated by reference in its entirety.

### FIELD OF THE INVENTION

The present invention relates to the field of vehicular parking systems.

### BACKGROUND OF THE INVENTION

Millions of people worldwide use cars and other vehicles every day. Some vehicles may be able to park in a privately-owned parking spot. Other vehicles may need to park in a public parking spot, for example, within a margin of a road or a street, or in proximity to a sidewalk that borders a road or a street (e.g., in parallel to the sidewalk).

In many cities and town, parking of vehicles on streets and roads may be subject to parking regulations. For example, some cities may allow free parking for a limited period of time (e.g., for two hours). Other cities may require the driver or the car owner to pay a parking fee (e.g., a fixed amount per hour); for example, by inserting coins into a parking meter which may be located at or near the curb of the road.

### SUMMARY OF THE INVENTION

Some embodiments of the present invention may comprise a vehicular parking system, as well and devices and methods thereof.

In accordance with some demonstrative embodiments of the present invention, a user associated with a vehicle may utilize a smartphone having a Parking Application, in order to actively signal to a remote parking server that the user begins a paid parking session. Subsequently, the user returns to his vehicle, ignites the vehicle, and enables a wireless connection between the smartphone and a wireless transceiver of the vehicle (e.g., Bluetooth pairing between a Bluetooth transceiver of the smartphone and a Bluetooth transceiver or network of the vehicle). The Parking Application detects such wireless connection or such Bluetooth pairing; and automatically proceeds to terminate the ongoing paid parking session, optionally after requesting confirmation from the user that he indeed desires to terminate the ongoing paid parking session.

### BRIEF DESCRIPTION OF THE DRAWINGS

FIG. 1 is a schematic block diagram illustration of a system, in accordance with some demonstrative embodiments of the present invention.

FIG. 2 is a schematic illustration demonstrating a parking-session commencement method, in accordance with some demonstrative embodiments of the present invention.

FIG. 3 is a schematic illustration demonstrating a parking-session termination method, in accordance with some demonstrative embodiments of the present invention.

FIG. 4 is a schematic illustration of a screen of a smartphone, demonstrating a request for user approval of initial Bluetooth pairing, in accordance with some demonstrative embodiments of the present invention.

FIG. 5 is a schematic illustration of a screen of a smartphone, demonstrating an application notification to the user about automatic termination of a paid parking session, in accordance with some demonstrative embodiments of the present invention.

FIG. 6 is a schematic illustration of a screen of a smartphone, demonstrating as incoming SMS notification to the user about automatic termination of a paid parking session, in accordance with some demonstrative embodiments of the present invention.

FIG. 7 is a schematic illustration of a screen of a smartphone, demonstrating a Settings screen or tab of a parking application, in accordance with some demonstrative embodiments of the present invention.

### DETAILED DESCRIPTION OF SOME EMBODIMENTS OF THE INVENTION

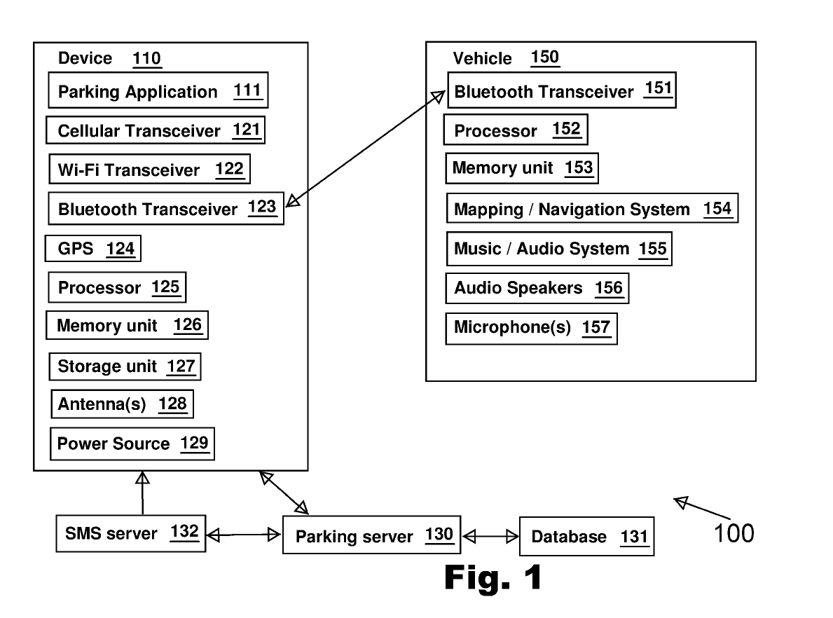

Reference is made to FIG. 1, which is a schematic block diagram illustration of a system 100, in accordance with some demonstrative embodiments of the present invention.

In accordance with some demonstrative embodiments of the present invention, a driver parks his vehicle in a public parking spot. The driver utilizes a portable electronic device 110 (e.g., a smartphone, a tablet, a smart-watch, or other mobile device) in order to launch or to open a Parking Application (“App”) 111, which may be installed on his portable electronic device 110, or which may be otherwise accessed wirelessly through the portable electronic device 110 (e.g., implemented as a Web application accessible via a Web browser).

The Parking Application 111 may allow the user to define a user profile, including for example: a unique username or user identifier (e.g., optionally utilizing the user's phone number as user identifier; or optionally utilizing the user's email address as user identifier); optionally, a password; one or more identifiers of one or more respective vehicles that are associated with the user (e.g., owned by the user; or otherwise utilized by the user, as a driver or as a passenger); one or more data-items describing payment method(s) defined by the user for the purpose of paying for vehicular parking (e.g., credit card data; debit card data; bank account data; electronic funds transfer data; cellular phone or land-line phone account number that allows a phone-user to charge debits to such phone account; or other suitable payment methods).

The user may click or select a “Start Paid Parking Session” button or link in the parking application 111. The portable electronic device 110 sends a wireless signal to a remote parking server 130, indicating to the remote parking server 130 that this particular user (e.g., indicated by its unique username, and/or by the vehicle license plate which is part of the user's profile) is now commencing a paid parking session for the pre-defined vehicle that is part of (or is associated with) that particular user.

The remote parking server 130 receives the wireless signal; and determines which user (or which user account, or which payment method) to debit for the paid parking session, and which vehicle is associated with the paid parking session that is commencing now. The remote parking server 130 updates a remote database 131, to indicate that this particular user and/or that this particular vehicle, are now starting a paid parking session; and further indicating the date-stamp and the time-stamp in which the paid parking session begun (e.g., the date-stamp and the time-stamp of wirelessly receiving the wireless signal from the Parking Application 111).

The remote parking server 130 may optionally send back to the portable electronic device 110, an acknowledgment signal indicating that the remote parking server 110 indeed received the “start paid parking session” signal, and indeed registered in its remote database 131 that a paid parking session has been started and is currently ongoing. Optionally, the Parking Application 111 may display or otherwise convey to the user, a message indicating that the paid parking session has successfully begun. The user of the vehicle may then leave his vehicle and depart from it.

The paid parking session is now in progress. During the paid parking session, a policeman or a parking enforcement person may visit the proximity of the parked vehicle; and may utilize a portable device in order to wirelessly query the remote parking server 130, whether or not the particular vehicle that is parking there is associated with an ongoing paid parking session; for example, by indicating the license plate number of the parked vehicle, and querying the remote parking database 131 whether or not an ongoing paid parking session is recorded as currently associated with that particular vehicle. The query response may allow the parking enforcement person to determine that the parked vehicle is associated with an ongoing paid parking session (and thus, does not require to issue a parking ticket); or, conversely, to determine that the parked vehicle is not associated with an ongoing paid parking session (and thus, a parking ticket or fine or other penalty may be issued to that vehicle).

Subsequently, the driver may return to his parked vehicle. In a conventional parking system, the driver is required to utilize his portable electronic device 110, and to launch or open again the Parking Application 111; and to actively press or select an “End Paid Parking Session” button or a link, in order to cause the portable electronic device 110 to actively indicate (via a wireless signal) to the remote parking server 130 that the paid parking session is now ending. Such a “parking-ended” signal causes the remote parking server 130 to update the remote database 131 to reflect that the ongoing parking session has ended; and to charge or debit the accumulated parking fee to the user's account or to the user's payment method. The remote parking server 130 may optionally comprise, or may be associated with or coupled to, a Short Messaging Service (SMS) server 132, which may be utilized in order to send acknowledgement notifications, status notifications, and/or other parking-related messages to the portable electronic device 110 of the user.

The Applicants have realized that many users and many drivers may forget to actively end a paid parking session, upon their return to the parked vehicle. The Applicants have realized that often, the driver is in a hurry to leave, or is also taking care of passengers and/or luggage, or is occupied with other tasks, or is occupied with other tasks (e.g., the driver is talking on his smartphone while approaching his vehicle and/or while entering his vehicle); and due to these and/or other reasons, the driver may forget to actively press the “End Paid Parking Session” button or link in the Parking Application 111.

The Applicants have realized that as a result, the ongoing parking session continues to progress, and the debits and charges to the user's account continue to accumulate and increase; even though the vehicle is no longer parked and is no longer obligated to pay any parking fees.

The Applicants have realized that this causes significant monetary loss for the user (e.g., the driver), who continues to accumulate and pay a parking fee even though his vehicle is no longer parking.

The Applicants have realized that there is a need for a practical and efficient solution that would trigger automatic termination of an ongoing paid parking session; without necessarily requiring the driver to remember to actively initiate a request to end the paid parking session.

In accordance with some demonstrative embodiments of the present invention, the portable electronic device 110 of the driver may automatically detect, deduce and/or determine that the driver has returned to his vehicle, and/or that the driver has begun to drive his vehicle (or is already driving his vehicle) away from his most-recent paid parking spot; and the portable electronic device 110 may automatically and autonomously initiate a process to end the previously-commenced paid parking session.

In accordance with a first embodiment of the present invention, the Parking Application 111 may determine, based on Bluetooth pairing existence, that the user (e.g., the driver) has returned to his parked vehicle, has entered his parked vehicle, and started the vehicle (e.g., signaling that the driver intends to drive away with the vehicle; and not just that the driver returned to the parked vehicle in order to retrieve a forgotten item).

In a demonstrative implementation, for example, portable electronic device 110 may optionally comprise: a cellular transceiver 121; a Wi-Fi transceiver 122; a Bluetooth transceiver 123; a Global Positioning System (GPS) component 124; a processor 125; a memory unit 126; a storage unit 127; one or more antennas 128; a power source 129; and other suitable hardware components and/or software components.

In this demonstrative implementation, for example, a vehicle 150 of the user may comprise a Bluetooth transceiver 151, and optionally a processor 152; and may optionally comprise, for example, a memory unit 153, a mapping/navigation system 154, a music/audio system 155 or entertainment system, one or more audio speakers 156, one or more microphones 157, and/or other suitable hardware components and/or software components; which may optionally be embedded in (or connected to, or affixed to, or mounted on) the chassis and/or cabin and/or dashboard of the vehicle.

Once the driver returns to his vehicle 150 and enters his vehicle 150, the driver may ignite the engine of the vehicle (e.g., by inserting and turning an ignition key; or by initiating a key-less ignition process). The driver may then actively pair between: (a) the Bluetooth transceiver 123 of his portable electronic device 111, and (b) the Bluetooth transceiver 151 of the vehicle 150. Optionally, in some implementations, such Bluetooth pairing may be performed automatically and/or autonomously, by the portable electronic device 111 and/or by the vehicle 150 (e.g., by the processor 125 and/or by the processor 152); for example, by utilizing a process for automatic or autonomous Bluetooth pairing upon sensing by a first Bluetooth transceiver the proximity to a second, nearby, Bluetooth transceiver; and optionally, by taking into account a prior user-confirmation of pairing between the two Bluetooth transceivers.

The Parking Application 111 may run in the background on the portable electronic device 110; since, for example, the driver had previously launched the Parking Application 111 when he had commenced the paid parking session. The Parking Application 111 may continuously monitor (or may listen to) Bluetooth events, and may detect that Bluetooth pairing has occurred. Upon detection that Bluetooth pairing has occurred, the Parking Application 111 may inquire with the user, by using an on-screen pop-up question or window (and/or by using an audible message or utterance), for example: “The parking application detected Bluetooth pairing with ‘David-25’, this may indicate that you perhaps returned to your car, would you like to End your currently-ongoing paid parking session?”. The Parking Application 111 may enable the user to input his feedback, for example, by selecting between “yes” or “no” on-screen interface elements (e.g., buttons, links), or by using voice or speech input. If the user conveys a positive answer to the query, then, the Parking Application 111 automatically sends an “End the Paid Parking Session” wireless signal to the remote parking server 130; which in turn acknowledges the receipt of the ending signal and the termination of the paid parking session; and the Parking Application 111 may then convey to the user that the paid parking session is indeed terminated.

In some embodiments, the Parking Application 111 on the portable electronic device 111 may initiate the process to terminate the paid parking session, immediately and automatically upon detection of a nearby Bluetooth transceiver that was pre-defined or pre-approved by the user as a Bluetooth device that may trigger a parking termination process; even without requiring actual Pairing of the two Bluetooth transceivers; and optionally, conditioned upon the user's active confirmation to a query message, that queries the user whether he indeed wishes to terminate the current paid parking session. In other embodiments, detection of actual Pairing of the two Bluetooth transceivers (the Bluetooth transceiver 125 of the portable electronic device 110, and the Bluetooth transceiver 152 of the vehicle 150) may be required as a preliminary condition for the Parking Application 111 to initiate the process of suggesting to the user to terminate the ongoing paid parking session.

In some embodiments, the Parking Application 111 may allow the user to define in advance which Bluetooth transceiver belongs to the vehicle 150; for example, by allowing the portable electronic device 110 to scan for nearby Bluetooth transceivers, enabling the user to select a particular Bluetooth transceiver from a list of one-or-more detected Bluetooth transceivers. In other embodiments, during the first time that the user utilizes the Parking Application 111 when he returns to his vehicle 150 and a first Bluetooth pairing occurs, then the Parking Application may ask the user whether or not a particular Bluetooth transceiver or a particular Bluetooth network (or ad-hoc network), which was now detected, is indeed his vehicular Bluetooth transceiver or network; and whether or not the user would like to automatically terminate his ongoing paid parking session based on the detected Bluetooth pairing. The query may ask the user to provide a “yes” or “no” answer; optionally, the query may allow the user to indicate to the Parking Application 111 that the particular Bluetooth network that was detected is not relevant to parking termination (e.g., an option of “No, and do not ask me again about this Bluetooth network”).

Optionally, the Parking Application 111 may comprise a “settings” or “preferences” page or tab or module, which may enable the user to command the Parking Application to actively “forget” or discard a previously-approved or previously-confirmed Bluetooth network or transceiver; such that subsequent detection of Bluetooth pairing, with that Bluetooth transceiver or network, would not trigger the initiation of the process for terminating an ongoing paid parking session.

In accordance with some embodiments of the present invention, optionally, the Parking Application 111 may include in the wireless signal, that is sent to the remote parking server 130 in order to terminate an ongoing paid parking session, a field or flag or data-item in order to indicate which type of termination is conveyed; for example, a field with a value of “1” or “manual”, to indicate that the parking session termination signal is sent because the driver has actively requested to terminate the parking session and without the Parking Application 111 detecting a Bluetooth pairing; or, a field with a value of “2” or “Bluetooth-Pairing-Detected”, to indicate that the termination of the ongoing parking session was confirmed by the driver after the Parking Application 111 had detected Bluetooth pairing and had suggested to the driver to terminate the ongoing parking session. Optionally, other suitable values or flags may be included in the termination message; for example, to differentiate between a situation in which the termination was entirely autonomous by the Parking Application 111, and a situation in which the termination was semi-autonomous such that the Parking Application initiated the termination but also obtained the user's confirmation prior to commanding such termination. Other suitable flags or fields may be used. Such flags or fields may be utilized by the remote server, in order to collect data about the usefulness of the autonomous parking termination feature of the Parking Application, with relation to a particular user, or a group of users, or an entire population.

In some embodiments, the “settings” or “preferences” page or tab or screen of the Parking Application 111, may allow the user to activate and de-activate the feature of automatic parking-session termination upon detection of Bluetooth pairing. In some embodiments, the Parking Application 111 may utilize a binary setting, such as, whether to activate or de-activate this feature. In other embodiments, more than two modes of operation may be used, allowing the user a flexible selection among multiple options based on his preference; for example, the user may select between three possible modes: (a) de-activate the feature entirely; (b) activate the feature but always ask me for manual confirmation before actually terminating a paid parking session; (c) activate the feature and execute it entirely automatically without asking me every time whether or not to terminate an active paid parking session (yet immediately notify me audibly with an audio message that the parking session has been terminated). Other suitable options may be used.

In some embodiments, the detection of the fact that the user has returned to his vehicle and/or started the engine and/or is leaving and/or intends to leave the parking spot, may be based on, or may take into account, one or more other criteria, in addition to or instead of the Bluetooth pairing; for example: Bluetooth network existence; Near Field Communication (NFC) transceiver(s) and/or NFC link establishment; Wi-Fi network detection (e.g., detecting that the vehicle 150 is ignited and that the Wi-Fi transceiver of the portable electronic device has freshly connected to the Wi-Fi network of the vehicle); location-based data and/or location data and/or GPS data (e.g., indicating that the portable electronic device 110 is located remotely from, or significantly remotely from, the original parking location, by at least a pre-defined distance); accelerometer data and/or compass data and/or gyroscope data (e.g., indicating that the portable electronic device 111 is moving at a speed that is greater than a pre-defined threshold value, thereby indicating that the user is probably already driving); and/or other suitable parameters, which may be used instead of, or in addition to, or in combination with, Bluetooth network detection and/or Bluetooth pairing detection.

The present invention may also be used in conjunction with a system that does not necessarily require a remote parking server 130; for example, a system in which the Parking Application 111 is implemented as a stand-alone application, allowing the user to securely add funds (e.g., monetary credit) to the parking application, and subsequently decreasing the available credit locally without necessarily contacting a remote parking server. Such implementations may similarly benefit from the features of the present invention, allowing the Parking Application to autonomously detect that an ongoing paid parking session should be terminated; and allowing the user to enjoy the benefit of saving parking fees, upon automatic detection of departing of the vehicle from the parking spot.

In accordance with some demonstrative embodiments of the present invention, the feature of automatic detection of vehicular departing from the paid parking spot may be a free feature that may be offered freely to users of the Parking Application 111 (e.g., for a limited time, or for unlimited time). In other embodiments, this may be a premium feature, that may be available only to paying users that pay a one-time fee or a periodic fee in order to benefit from such feature.

In some embodiments, the portable electronic device 110 and/or the Parking Application 111 and/or the parking server 130, may be able to calculate or to estimate the monetary saving that was achieved by activating and using the feature of automatic detection of vehicle deportation from a paid parking spot; and may report this information to the user or driver; and may accumulate data across time and/or across drivers, for example, to calculate a cumulative savings amount since the feature was activated, or a cumulative savings amount per week or per month or per car, or an average cumulative savings amount per car or per user (e.g., per a period of time, such as, per month or per week).

For example, the Parking Application 111 may detect the geo-spatial or geographical location of the parked car, by using the GPS element or other suitable location-based component (e.g., based on cellular triangulation, or cellular cell connection, or based on an available Wi-Fi network, or the like). Based on the geographical location, the parking server 130 determines to which authority or entity the parking fee should be paid (e.g., to which town or city); and also determines the parking rate per hour or per time-unit and/or the maximum time-slot for paid parking (e.g., if the vehicle is parking in the city of Springfield, then the parking fee is 6 dollars per hour, with a limit of three consecutive parking hours); by using a lookup table or database that converts from GPS coordinates (or other geographical identifier or location) to a particular municipality or town or city or village or state, and stores therein the applicable parking fees or parking rates, and the parking time limits and allowed time-slots.

In a demonstrative example, the driver parks his vehicle in Springfield, which charges 6 dollars per hour, and has a parking time limit of 3 hours. The driver returns to his vehicle and drives away after 70 minutes, forgetting to click on the “end the paid parking session” button in his Parking Application 111. However, the Parking Application 111 detects the Bluetooth pairing, and automatically (and/or after obtaining the user's confirmation) terminates the paid parking session. The Parking Application 111 may now calculate as follows: that the driver actually paid a total parking fee of 1.1 hours×6 dollars per hour, or a total paid amount of 7 dollars; whereas, without the automatic termination, the paid parking session would have continued until the municipal time-limit of 3 hours is reached, with a total parking fee of 3 hours×6 dollars per hour=18 dollars. The Parking Application 111 may calculate that the feature of automatic termination of the paid session, has just saved to the driver a parking fee of 18−7 dollars, which is a saving of 11 dollars. The Parking Application 111 may notify the driver about this monetary savings amount, directly through the Parking Application; or alternatively, or additionally, the remote parking server 130 may notify this information to the driver (e.g., via an SMS message).

The Applicants have calculated and estimated that many millions of dollars in undue parking fees, may be saved cumulatively each year, by utilizing the system, device and/or method of the present invention. In a demonstrative calculation, for example: a geographical region (e.g., a state or a city or a country) has 100,000 active users who utilize the parking system; and the parking fee is 5 dollars per hour. Each user utilizes the parking system 5 times per month, on average. On average, the maximum allowed parking time is 3 hours; and on average, each user leaves his parking spot after 1 hour. On average, and also based on a survey conducted by the Applicants, 30 percent of the active users forget to actively terminate their paid parking session, 50 percent of the times that they return to their car. Accordingly: each user loses 2 hours of paid parking, at 5 dollars per hour, which is a loss of 10 dollars per “forgetting” incident. The geographical region has 100,000 active users, who utilize the system 5 times per month; equivalent to 500,000 parking sessions per month. Out of those 500,000 parking sessions, 30 percent of users have a “forgetting incident” every-other-time; and thus, 15% of the parking sessions (namely, 75,000 parking sessions, per month) are “forgetting incidents”. Each “forgetting incident” is typically associated with a loss of 10 dollars; and thus, in just one month, the geographical region accumulates 750,000 dollars of undue parking fees that were collected; which is equivalent to 9 million dollars of undue parking fees per year, for a geographical region of 100,000 users. This significant monetary loss, or unduly collected parking fees, may be saved by using the automated termination of parking sessions, in accordance with the present invention. Other suitable numbers, calculations, estimates and/or results may be used.

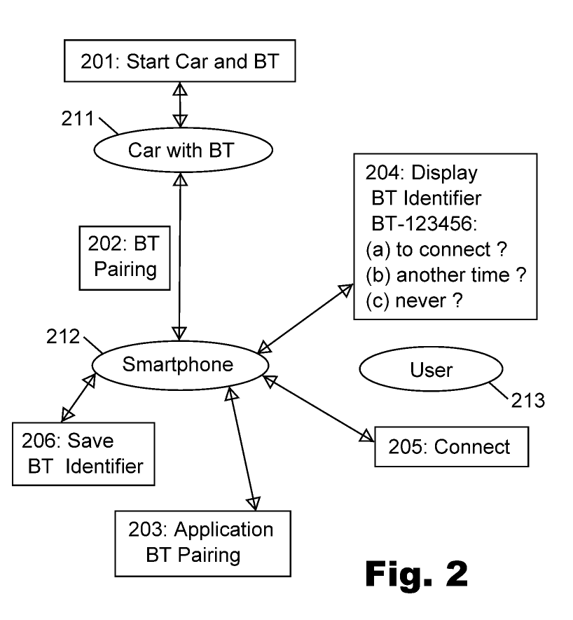

FIG. 2 is a schematic illustration demonstrating a parking-session commencement method, in accordance with some demonstrative embodiments of the present invention. The method may be implemented by one or more suitable units or participants, for example, a car equipped with a Bluetooth transceiver (211), and a smartphone (212) carried by a user (213).

In step 201, the car is started or ignited, and the Bluetooth transceiver of the car is active. In step 202, Bluetooth pairing is performed between the car's Bluetooth transceiver and the smartphone's Bluetooth transceiver. In step 203, the parking application of the smartphone may perform Bluetooth application pairing. In step 204, the smartphone displays to the user a Bluetooth network identifier, and presents to the user one or more user-selectable options or commands; such as, whether to connect, or whether to decide at another time, or whether not to connect (not now, and not subsequently). In step 205, the user commands the smartphone to connect to the identified Bluetooth network, which the user identifies as his car's Bluetooth network or his car's Bluetooth transceiver. In step 206, the smartphone saves (e.g., locally within the smartphone) the Bluetooth identifier, with a suitable tag or indicator or flag; as this Bluetooth identifier may later be used for automatic termination of an ongoing parking session.

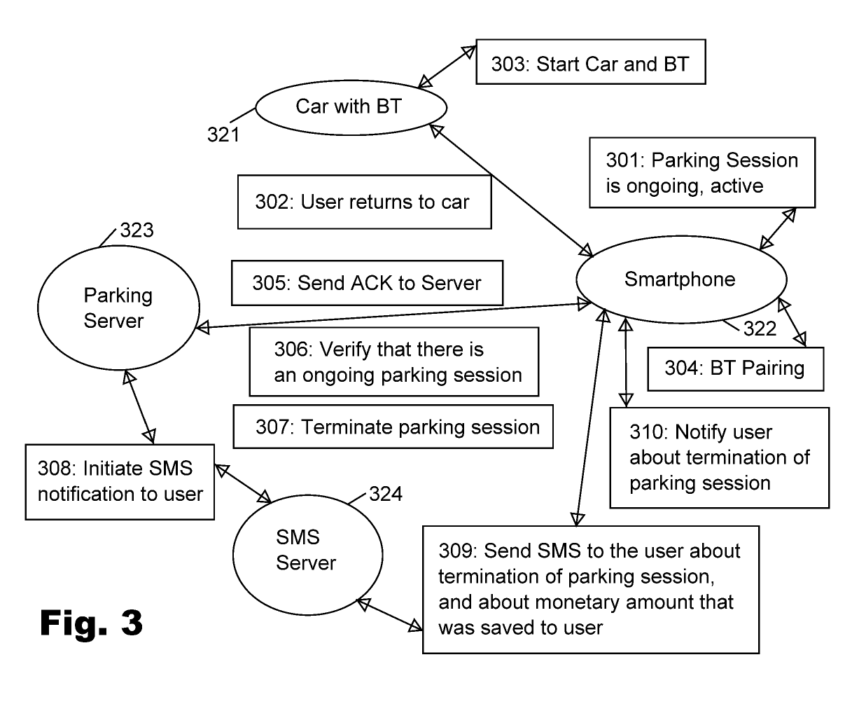

FIG. 3 is a schematic illustration demonstrating a parking-session termination method, in accordance with some demonstrative embodiments of the present invention. The method may be implemented by one or more suitable units or participants, for example, a car equipped with a Bluetooth transceiver (321), a smartphone (322) carried by a user, a remote Parking Server (323), and an optional SMS server (324). Other suitable operations may be used.

In step 301, a paid parking session is currently active and ongoing. In step 302, the user who carries the smartphone returns to his car. In step 303, the car is started or ignited, and the Bluetooth transceiver of the car is activated. In step 304, Bluetooth pairing is performed between the Bluetooth transceiver of the car and the Bluetooth transceiver of the smartphone. In step 305, the smartphone sends an Acknowledgment message or signal (ACK) to the parking server. In step 306, the parking server checks or verifies that there indeed exists an ongoing paid parking session that is associated with that smartphone; and in step 307, the parking server terminates the ongoing paid parking session (e.g., automatically; or optionally, after requesting manual confirmation of the user via his smartphone). In step 308, the parking server may optionally initiate an SMS notification to the user, which in step 309 may be sent to the smartphone of the user by the SMS server, to notify the user that the ongoing parking session is terminated, and optionally to notify the user the monetary amount that was paid for the parking and/or the monetary amount that was saved to due to the automatic termination of the ongoing parking session. Additionally or alternatively, in step 310, the smartphone may notify the user (e.g., via the parking application, via a Push notification, via email, or by other means), that the ongoing parking session is terminated, and optionally to notify the user the monetary amount that was paid for the parking and/or the monetary amount that was saved to due to the automatic termination of the ongoing parking session. Other suitable operations may be used.

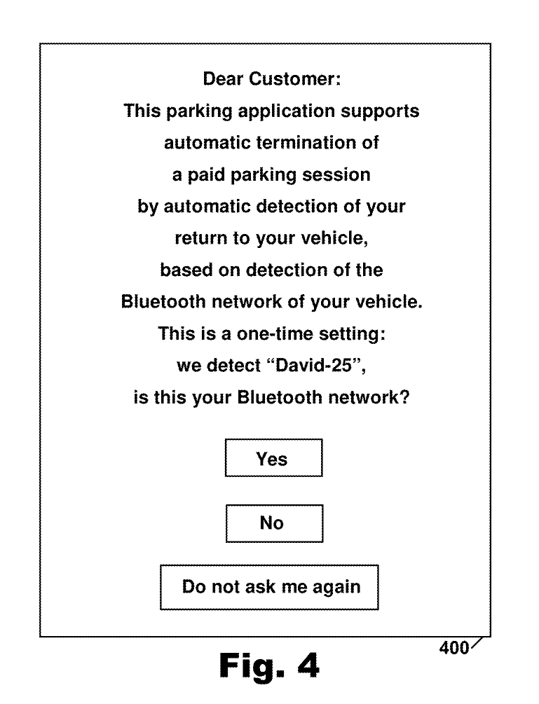

Reference is further made to FIGS. 4-7, which demonstrate screens, messages, features and/or user interface elements, which may be presented to a user through a smartphone or tablet or other suitable electronic device, in accordance with some demonstrative embodiments of the present invention.

FIG. 4 is a schematic illustration of a screen 400 of a smartphone, demonstrating a request for user approval of initial Bluetooth pairing, in accordance with some demonstrative embodiments of the present invention. For example, before commencement of a paid parking session, or as part of the commencement, or immediately after its commencement, the parking application may request the user to confirm (e.g., one time only, for future parking sessions too) that the smartphone can be paired with the currently-identified Bluetooth network or transceiver (e.g., of the car). The user may respond with “yes”, or with “no”, or with “do not ask me again” (e.g., if the Bluetooth identifier that is shown is not known to the user). Upon selection of “yes”, Bluetooth pairing is automatically confirmed for the currently-starting paid parking session, and is also pre-confirmed for future or subsequent paid parking sessions that would commence in the future, on other days and in other geo-locations.

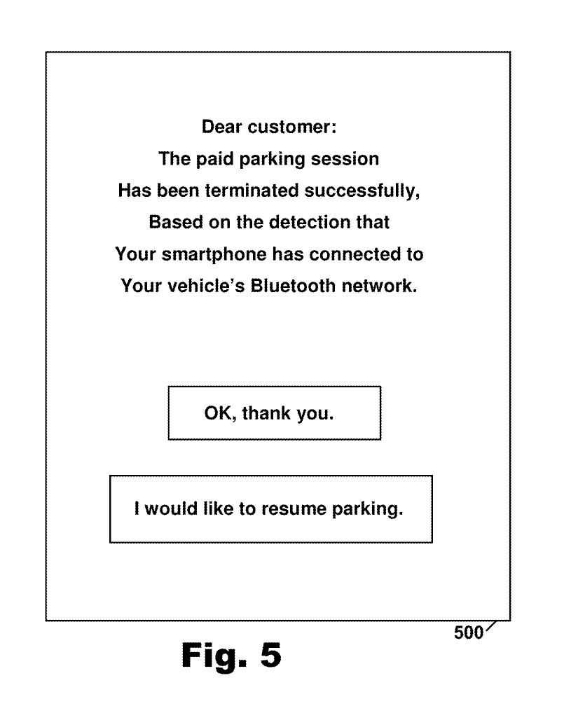

FIG. 5 is a schematic illustration of a screen 500 of a smartphone, demonstrating an application notification to the user about automatic termination of a paid parking session, in accordance with some demonstrative embodiments of the present invention. Optionally, the user may be provided with GUI elements (e.g., buttons, links) that allow the user to convey his approval of the automatic termination; or alternatively, to convey that the user is actually not departing from the paid parking spot and that the user wishes to resume the paid parking session, which would then be re-initiated or would be otherwise resumed.

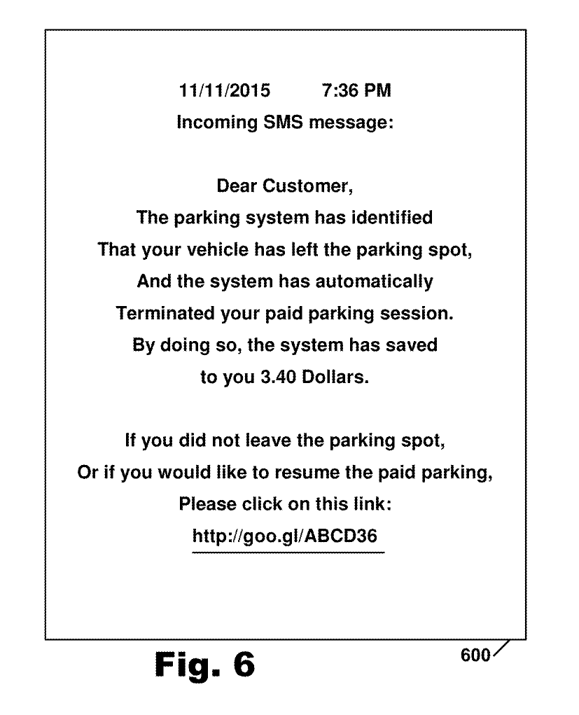

FIG. 6 is a schematic illustration of a screen 600 of a smartphone, demonstrating as incoming SMS notification to the user about automatic termination of a paid parking session, in accordance with some demonstrative embodiments of the present invention. Optionally, the user may be also notified about the monetary amount paid for parking, and/or about the monetary amount that was saved due to the automatic termination of the paid parking session. Optionally, the user may be provided with GUI elements (e.g., a hyperlink) that allows the user to convey his approval of the automatic termination; or alternatively, to convey that the user is actually not departing from the paid parking spot and that the user wishes to resume the paid parking session, which would then be re-initiated or would be otherwise resumed.

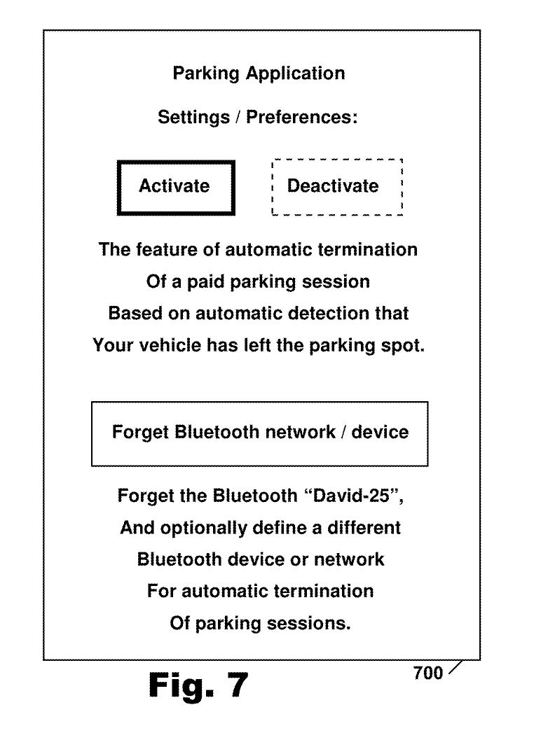

FIG. 7 is a schematic illustration of a screen 700 of a smartphone, demonstrating a Settings screen or tab of a parking application, in accordance with some demonstrative embodiments of the present invention. As shown in the top-region of the screen, the user may manually select whether to generally activate or to generally de-activate the feature of “automatic termination of an ongoing paid parking session based on automatic detection that the vehicle left the parking spot.” As shown in the lower-region of the screen, the user may manually command his smartphone to “forget” a previously-paired Bluetooth identifier or transceiver or network, such that automatic termination of parking session would not occur based on such Bluetooth identifier (unless or until the user re-approves that Bluetooth identifier, or another Bluetooth identifier, for that purpose).

The present invention may be implemented by a dedicated or specially-constructed system, which is not a “general purpose computer” and is not a “generic computer”. The system and methods of the present invention are not merely an abstract idea, and are significantly more than such an abstract idea. Rather, the present invention enables a novel and non-obvious association and inter-operability and communication-exchange among multiple hardware devices that are scattered among different locations. For example, the present invention may enable the inter-operability of a smartphone, a remote server, a parking server, a GPS unit of a smartphone, a Bluetooth transceiver of a smartphone, a Bluetooth transceiver of a vehicle, a vehicular network or system, an SMS server, a cellular transceiver of the smartphone (which may send and/or receive the data), a cellular transceiver of the parking server or associated with the parking server (which may send and/or receive the data), a Wi-Fi transceiver of the smartphone (which may send and/or receive the data), a Wi-Fi transceiver of the parking server (which may send and/or receive the data), a location-based system able to identify and utilize the current location of the vehicle and/or the smartphone and/or the co-located Bluetooth transceiver(s) in order to further utilize location-based information and also in order to construct or retrieve a location-based parking tariff and/or parking rules and/or parking policies, a monetary payment system or billing system or collection system to further enable the system to have further real-world effect and monetary effect; and/or a pay-per-use parking system that enables a parking inspector (e.g., policeman, municipal worker) to utilize a hand-held device in order to check whether a particular vehicle that parks on the street is associated with a paid parking session (or not associated, and thus should be issued a parking ticket or a parking fine). The present invention thus ties together in a unique manner these variety of hardware units, to enable them to perform new capabilities that were not achieved or envisioned in any conventional systems.

The present invention may further comprise a non-transitory storage medium or storage article, which stores thereon instructions or code that, if or when executed by a processor or a machine, cause such processor or machine to perform an automated method in accordance with the present invention.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

The system(s) and/or device(s) of the present invention may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), microphone(s), sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or device(s) of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

In some embodiments of the present invention, a vehicular parking system may include a parking server comprising: (a) a wireless communication transceiver to receive a first wireless communication signal, indicating that a user of a vehicle that is associated with a smartphone has commenced a paid parking session, (b) a parking session commencement unit that, in response to said first wireless communication signal, updates a parking record in said vehicular parking system, to indicate that said vehicle is associated with said paid parking session; (c) wherein said wireless communication transceiver, subsequently, is to receive a second wireless communication signal, indicating that said smartphone has autonomously determined to end said paid parking session, based on an autonomous analysis of said smartphone and not based on a manual user-command to end the paid parking session; (d) a parking session termination unit that, in response to said second wireless communication signal, updates said parking record in said vehicular parking system, to indicate that said vehicle is no longer associated with any paid parking session.

In some embodiments, said second wireless communication signal is received based on an autonomous determination of said smartphone that is based exclusively on identification of Bluetooth pairing between: (i) a Bluetooth transceiver of said smartphone, and (ii) a Bluetooth transceiver of said vehicle.

In some embodiments, said second wireless communication signal is received based on an autonomous determination of said smartphone that is based at least on identification of Bluetooth pairing between: (i) a Bluetooth transceiver of said smartphone, and (ii) a Bluetooth transceiver of said vehicle.

In some embodiments, said second wireless communication signal is received based on an autonomous determination of said smartphone that is based exclusively on: (I) identification of Bluetooth pairing between: (i) a Bluetooth transceiver of said smartphone, and (ii) a Bluetooth transceiver of said vehicle; and (II) determination by a Global Positioning System (GPS) unit of said smartphone, that said smartphone, which is currently paired via Bluetooth to said vehicle, is located away from a parking spot that was originally associated with said paid parking session of said vehicle.

In some embodiments, said second wireless communication signal is received based on an autonomous determination of said smartphone that is based at least on: (I) identification of Bluetooth pairing between: (i) a Bluetooth transceiver of said smartphone, and (ii) a Bluetooth transceiver of said vehicle; and (II) determination by a Global Positioning System (GPS) unit of said smartphone, that said smartphone, which is currently paired via Bluetooth to said vehicle, is located away from a parking spot that was originally associated with said paid parking session of said vehicle.

In some embodiments, said second wireless communication signal is received based on an autonomous determination of said smartphone that is based on: (I) identification of Bluetooth pairing between: (i) a Bluetooth transceiver of said smartphone, and (ii) a Bluetooth transceiver of said vehicle; and (II) a wireless communication signal received from said smartphone, indicating that said user has provided a manual user-confirmation to an autonomous proposal of said smartphone to terminate said paid parking session based on identified Bluetooth pairing between said smartphone and said vehicle.

In some embodiments, said second wireless communication signal is received based on an autonomous determination of said smartphone that is based on, at least, an aggregated combination of: (I) identification of Bluetooth pairing between: (i) a Bluetooth transceiver of said smartphone, and (ii) a Bluetooth transceiver of said vehicle; and (II) determination by a Global Positioning System (GPS) unit of said smartphone, that said smartphone, which is currently paired via Bluetooth to said vehicle, is located away from a parking spot that was originally associated with said paid parking session of said vehicle; and (III) a wireless communication signal received from said smartphone, indicating that said user has provided a manual user-confirmation to an autonomous proposal of said smartphone to terminate said paid parking session based on identified Bluetooth pairing between said smartphone and said vehicle.

In some embodiments, the parking server comprises: an automated billing unit to generate a parking bill, which corresponds to paid parking of said vehicle during a parking time-slot that: (i) begins at the time of receiving said first wireless communication signal, and (ii) ends at the time of receiving said second wireless communication signal indicating autonomous termination of the paid parking session by said smartphone.

In some embodiments, the parking server comprises: an automated billing unit to generate a parking bill, which corresponds to paid parking of said vehicle during a parking time-slot that: (i) begins at the time of receiving said first wireless communication signal, and (ii) ends at the time of receiving said second wireless communication signal indicating autonomous termination of the paid parking session by said smartphone; an automated collection unit to charge the monetary amount of said parking bill to a pre-defined payment account of said user.

In some embodiments, the parking server comprises: an automated billing unit to generate a parking bill, which corresponds to paid parking of said vehicle during a parking time-slot that: (i) begins at the time of receiving said first wireless communication signal, and (ii) ends at the time of receiving said second wireless communication signal indicating autonomous termination of the paid parking session by said smartphone; wherein the automated billing unit is to generate said parking bill by further taking into account a particular parking tariff of parking at a municipal region in which said vehicle was located during said paid parking session, based on a wireless communication signal received from said smartphone and indicating the location of said vehicle at commencement of said paid parking session as determined by a Global Positioning System (GPS) unit of said smartphone.

In some embodiments, the parking server comprises: an automated billing unit to generate a parking bill, which corresponds to paid parking of said vehicle during a parking time-slot that: (i) begins at the time of receiving said first wireless communication signal, and (ii) ends at the time of receiving said second wireless communication signal indicating autonomous termination of the paid parking session by said smartphone; wherein the automated billing unit is to generate said parking bill by further taking into account a particular parking tariff of parking at a municipal region in which said vehicle was located during said paid parking session, based on a wireless communication signal received from said smartphone and indicating the location of said vehicle at commencement of said paid parking session as determined by a Global Positioning System (GPS) unit of said smartphone; an automated collection unit to charge the monetary amount of said parking bill to a pre-defined payment account of said user.

In some embodiments, the parking server comprises: a parking fee saving estimator, to estimate a monetary saving amount indicating to said user a monetary amount that said user saved due to the autonomous termination of the paid parking session by said smartphone of the user.

In some embodiments, the parking server comprises: a parking fee saving estimator, to estimate a monetary saving amount indicating to said user a monetary amount that said user saved due to the autonomous termination of the paid parking session by said smartphone of the user; wherein said wireless communication transceiver is to wirelessly transmit to said smartphone of said user, a wireless communication signal that triggers said smartphone to display to the user a message indicating said monetary saving amount.

In some embodiments, the parking server comprises: a parking fee saving estimator, to estimate a monetary saving amount indicating to said user a monetary amount that said user saved due to the autonomous termination of the paid parking session by said smartphone of the user; a Short Message Service (SMS) transceiver (or unit, or transmitter, or server, or gateway) to wirelessly transmit to said smartphone of said user, an SMS message indicating said monetary saving amount.

In some embodiments, the parking server comprises: a parking fee saving estimator, to estimate a monetary saving amount indicating to said user a monetary amount that said user saved due to the autonomous termination of the paid parking session by said smartphone of the user; wherein the parking fee saving estimator is to determine: (i) a maximum allowed parking time that is allowed for a paid parking session at a particular location in which said vehicle parked during said paid parking session; (ii) an actual parking time of said paid parking session that was terminated based on autonomous determination of said smartphone; (iii) a difference between said maximum allowed parking time and said actual parking time; (iv) a product of multiplying said difference of step (iii), by a parking tariff that is associated with said particular location.

In some embodiments, the parking server comprises: a parking fee saving estimator, to estimate a monetary saving amount indicating to said user a monetary amount that said user saved due to the autonomous termination of the paid parking session by said smartphone of the user; wherein the parking fee saving estimator is to determine: (i) a maximum allowed parking time that is allowed for a paid parking session at a particular location in which said vehicle parked during said paid parking session; (ii) an actual parking time of said paid parking session that was terminated based on autonomous determination of said smartphone; (iii) a difference between said maximum allowed parking time and said actual parking time; (iv) a product of multiplying said difference of step (iii), by a parking tariff that is associated with said particular location; wherein said wireless communication transceiver is to wirelessly transmit to said smartphone of said user, a wireless communication signal that triggers said smartphone to display to the user a message indicating said monetary saving amount.

In some embodiments, the parking server comprises: a parking fee saving estimator, to estimate a monetary saving amount indicating to said user a monetary amount that said user saved due to the autonomous termination of the paid parking session by said smartphone of the user; wherein the parking fee saving estimator is to determine: (i) a maximum allowed parking time that is allowed for a paid parking session at a particular location in which said vehicle parked during said paid parking session; (ii) an actual parking time of said paid parking session that was terminated based on autonomous determination of said smartphone; (iii) a difference between said maximum allowed parking time and said actual parking time; (iv) a product of multiplying said difference of step (iii), by a parking tariff that is associated with said particular location; a Short Message Service (SMS) transceiver to wirelessly transmit to said smartphone of said user, an SMS message indicating said monetary saving amount.

In some embodiments, a smartphone (or other hand-held or portable electronic device) comprises: a Bluetooth transceiver to perform Bluetooth pairing with a vehicular Bluetooth transceiver of a vehicle; a wireless communication transceiver to wirelessly send to a parking server, a first wireless communication signal indicating that a user of said vehicle that is associated with said smartphone has commenced a paid parking session; a parking-termination determination unit, to autonomously determine to terminate said paid parking session of said vehicle, based on an autonomous analysis by the parking-termination determination unit of said smartphone and not based on a manual user-command to end the paid parking session.

In some embodiments, said wireless communication transceiver is to wirelessly send to said parking server, based on a signal from said parking-termination determination unit, a second wireless communication signal indicating that said smartphone has autonomously determined to end said paid parking session.

In some embodiments, said parking-termination determination unit is to autonomously determine to terminate said paid parking session of said vehicle based exclusively on identification of Bluetooth pairing between: (i) the Bluetooth transceiver of said smartphone, and (ii) the vehicular Bluetooth transceiver of said vehicle.

In some embodiments, said parking-termination determination unit is to autonomously determine to terminate said paid parking session of said vehicle based at least on identification of Bluetooth pairing between: (i) the Bluetooth transceiver of said smartphone, and (ii) the vehicular Bluetooth transceiver of said vehicle.

In some embodiments, said parking-termination determination unit is to autonomously determine to terminate said paid parking session of said vehicle based exclusively on: (I) identification of Bluetooth pairing between: (i) the Bluetooth transceiver of said smartphone, and (ii) the vehicular Bluetooth transceiver of said vehicle; and (II) determination by a Global Positioning System (GPS) unit of said smartphone, that said smartphone, which is currently paired via Bluetooth to said vehicle, is located away from a parking spot that was originally associated with said paid parking session of said vehicle.

In some embodiments, said parking-termination determination unit is to autonomously determine to terminate said paid parking session of said vehicle based at least on: (I) identification of Bluetooth pairing between: (i) the Bluetooth transceiver of said smartphone, and (ii) the vehicular Bluetooth transceiver of said vehicle; and (II) determination by a Global Positioning System (GPS) unit of said smartphone, that said smartphone, which is currently paired via Bluetooth to said vehicle, is located away from a parking spot that was originally associated with said paid parking session of said vehicle.

In some embodiments, said parking-termination determination unit is to autonomously determine to terminate said paid parking session of said vehicle based on: (I) identification of Bluetooth pairing between: (i) the Bluetooth transceiver of said smartphone, and (ii) the vehicular Bluetooth transceiver of said vehicle; and (II) a received user-confirmation of an autonomous proposal of said parking-termination determination unit to terminate said paid parking session based on identified Bluetooth pairing between said smartphone and said vehicle.

In some embodiments, said parking-termination determination unit is to autonomously determine to terminate said paid parking session of said vehicle based on: (I) identification of Bluetooth pairing between: (i) the Bluetooth transceiver of said smartphone, and (ii) the vehicular Bluetooth transceiver of said vehicle; and (II) determination by a Global Positioning System (GPS) unit of said smartphone, that said smartphone, which is currently paired via Bluetooth to said vehicle, is located away from a parking spot that was originally associated with said paid parking session of said vehicle; and (III) a received user-confirmation of an autonomous proposal of said parking-termination determination unit to terminate said paid parking session based on identified Bluetooth pairing between said smartphone and said vehicle.

In some embodiments, the wireless communication transceiver is to receive a message indicating an automatically-generated parking bill, which corresponds to paid parking of said vehicle during a parking time-slot that: (i) begins at the time of sending said first wireless communication signal, and (ii) ends at the time of sending said second wireless communication signal indicating autonomous termination of the paid parking session by said smartphone.

In some embodiments, the wireless communication transceiver is to receive a message indicating an automatically-generated parking bill, which corresponds to paid parking of said vehicle during a parking time-slot that: (i) begins at the time of sending said first wireless communication signal, and (ii) ends at the time of sending said second wireless communication signal indicating autonomous termination of the paid parking session by said smartphone; wherein said parking bill is generated by further taking into account a particular parking tariff of parking at a municipal region in which said vehicle was located during said paid parking session, based on a wireless communication signal received from said smartphone and indicating the location of said vehicle at commencement of said paid parking session as determined by a Global Positioning System (GPS) unit of said smartphone.

In some embodiments, the wireless communication transceiver is to receive a message indicating an automatically-generated estimate of monetary saving amount, and to convey to said user a monetary amount that said user saved due to the autonomous termination of the paid parking session by said smartphone.

In some embodiments, the wireless communication transceiver is to receive a message indicating an automatically-generated estimate of monetary saving amount, and to convey to said user via a push notification a monetary amount that said user saved due to the autonomous termination of the paid parking session by said smartphone.

In some embodiments, the automatically-generated estimate of monetary saving amount is determined based on: (i) a maximum allowed parking time that is allowed for a paid parking session at a particular location in which said vehicle parked during said paid parking session; (ii) an actual parking time of said paid parking session that was terminated based on autonomous determination of said smartphone; (iii) a difference between said maximum allowed parking time and said actual parking time; (iv) a product of multiplying said difference of step (iii), by a parking tariff that is associated with said particular location.

In some embodiments, a process intended for execution by a vehicular parking system, may comprise: (a) at a vehicular parking server, receiving a first wireless communication signal, indicating that a user of a vehicle that is associated with a smartphone has commenced a paid parking session, (b) at a parking session commencement unit of said vehicular parking server, in response to said first wireless communication signal, updating a parking record in said vehicular parking system, to indicate that said vehicle is associated with said paid parking session; (c) at said vehicular parking server, subsequently, receiving a second wireless communication signal, indicating that said smartphone has autonomously determined to end said paid parking session, based on an autonomous analysis of said smartphone and not based on a manual user-command to end the paid parking session; (d) at a parking session termination unit of said vehicular parking server, in response to said second wireless communication signal, updating said parking record in said vehicular parking system, to indicate that said vehicle is no longer associated with any paid parking session.

In some embodiments, said second wireless communication signal is received based on an autonomous determination of said smartphone that is based exclusively on identification of Bluetooth pairing between: (i) a Bluetooth transceiver of said smartphone, and (ii) a Bluetooth transceiver of said vehicle.

In some embodiments, said second wireless communication signal is received based on an autonomous determination of said smartphone that is based at least on identification of Bluetooth pairing between: (i) a Bluetooth transceiver of said smartphone, and (ii) a Bluetooth transceiver of said vehicle.

In some embodiments, said second wireless communication signal is received based on an autonomous determination of said smartphone that is based exclusively on: (I) identification of Bluetooth pairing between: (i) a Bluetooth transceiver of said smartphone, and (ii) a Bluetooth transceiver of said vehicle; and (II) determination by a Global Positioning System (GPS) unit of said smartphone, that said smartphone, which is currently paired via Bluetooth to said vehicle, is located away from a parking spot that was originally associated with said paid parking session of said vehicle.

In some embodiments, said second wireless communication signal is received based on an autonomous determination of said smartphone that is based at least on: (I) identification of Bluetooth pairing between: (i) a Bluetooth transceiver of said smartphone, and (ii) a Bluetooth transceiver of said vehicle; and (II) determination by a Global Positioning System (GPS) unit of said smartphone, that said smartphone, which is currently paired via Bluetooth to said vehicle, is located away from a parking spot that was originally associated with said paid parking session of said vehicle.

In some embodiments, said second wireless communication signal is received based on an autonomous determination of said smartphone that is based on: (I) identification of Bluetooth pairing between: (i) a Bluetooth transceiver of said smartphone, and (ii) a Bluetooth transceiver of said vehicle; and (II) a wireless communication signal received from said smartphone, indicating that said user has provided a manual user-confirmation to an autonomous proposal of said smartphone to terminate said paid parking session based on identified Bluetooth pairing between said smartphone and said vehicle.

In some embodiments, said second wireless communication signal is received based on an autonomous determination of said smartphone that is based on, at least, an aggregated combination of: (I) identification of Bluetooth pairing between: (i) a Bluetooth transceiver of said smartphone, and (ii) a Bluetooth transceiver of said vehicle; and (II) determination by a Global Positioning System (GPS) unit of said smartphone, that said smartphone, which is currently paired via Bluetooth to said vehicle, is located away from a parking spot that was originally associated with said paid parking session of said vehicle; and (III) a wireless communication signal received from said smartphone, indicating that said user has provided a manual user-confirmation to an autonomous proposal of said smartphone to terminate said paid parking session based on identified Bluetooth pairing between said smartphone and said vehicle.

In some embodiments, the process comprises: automatically generating a parking bill, which corresponds to paid parking of said vehicle during a parking time-slot that: (i) begins at the time of receiving said first wireless communication signal, and (ii) ends at the time of receiving said second wireless communication signal indicating autonomous termination of the paid parking session by said smartphone.

In some embodiments, the process comprises: automatically generating a parking bill, which corresponds to paid parking of said vehicle during a parking time-slot that: (i) begins at the time of receiving said first wireless communication signal, and (ii) ends at the time of receiving said second wireless communication signal indicating autonomous termination of the paid parking session by said smartphone; automatically charging the monetary amount of said parking bill to a pre-defined payment account of said user.

In some embodiments, the process comprises: automatically generating a parking bill, which corresponds to paid parking of said vehicle during a parking time-slot that: (i) begins at the time of receiving said first wireless communication signal, and (ii) ends at the time of receiving said second wireless communication signal indicating autonomous termination of the paid parking session by said smartphone; wherein said parking bill is automatically generated by further taking into account a particular parking tariff of parking at a municipal region in which said vehicle was located during said paid parking session, based on a wireless communication signal received from said smartphone and indicating the location of said vehicle at commencement of said paid parking session as determined by a Global Positioning System (GPS) unit of said smartphone.

In some embodiments, the process comprises: automatically determining a monetary saving amount that indicates to said user a monetary amount that said user saved due to the autonomous termination of the paid parking session by said smartphone of the user; wirelessly transmitting to said smartphone of said user, a wireless communication signal that triggers said smartphone to display to the user a message indicating said monetary saving amount.

In some embodiments, the process comprises: automatically determining a monetary saving amount that indicates to said user a monetary amount that said user saved due to the autonomous termination of the paid parking session by said smartphone of the user; wherein said determining of the monetary saving amount is performed based on determining: (i) a maximum allowed parking time that is allowed for a paid parking session at a particular location in which said vehicle parked during said paid parking session; (ii) an actual parking time of said paid parking session that was terminated based on autonomous determination of said smartphone; (iii) a difference between said maximum allowed parking time and said actual parking time; (iv) a product of multiplying said difference of step (iii), by a parking tariff that is associated with said particular location.

In some embodiments, a method intended for execution by a smartphone, may comprise: at a Bluetooth transceiver of said smartphone, performing Bluetooth pairing with a vehicular Bluetooth transceiver of a vehicle; at a wireless communication transceiver of said smartphone, wirelessly sending to a parking server, a first wireless communication signal indicating that a user of said vehicle that is associated with said smartphone has commenced a paid parking session; at a parking-termination determination unit of said smartphone, autonomously determining to terminate said paid parking session of said vehicle, based on an autonomous analysis by the parking-termination determination unit of said smartphone and not based on a manual user-command to end the paid parking session.

In some embodiments, the method comprises: at said wireless communication transceiver of said smartphone, wirelessly sending to said parking server, based on a signal from said parking-termination determination unit, a second wireless communication signal indicating that said smartphone has autonomously determined to end said paid parking session.

In some embodiments, the method comprises: at said parking-termination determination unit, autonomously determining to terminate said paid parking session of said vehicle based exclusively on identification of Bluetooth pairing between: (i) the Bluetooth transceiver of said smartphone, and (ii) the vehicular Bluetooth transceiver of said vehicle.

In some embodiments, the method comprises: at said parking-termination determination unit, autonomously determining to terminate said paid parking session of said vehicle based at least on identification of Bluetooth pairing between: (i) the Bluetooth transceiver of said smartphone, and (ii) the vehicular Bluetooth transceiver of said vehicle.

In some embodiments, the method comprises: at said parking-termination determination unit, autonomously determining to terminate said paid parking session of said vehicle based on: (I) identification of Bluetooth pairing between: (i) the Bluetooth transceiver of said smartphone, and (ii) the vehicular Bluetooth transceiver of said vehicle; and (II) determination by a Global Positioning System (GPS) unit of said smartphone, that said smartphone, which is currently paired via Bluetooth to said vehicle, is located away from a parking spot that was originally associated with said paid parking session of said vehicle.

In some embodiments, the method comprises: at said parking-termination determination unit, autonomously determining to terminate said paid parking session of said vehicle based on: (I) identification of Bluetooth pairing between: (i) the Bluetooth transceiver of said smartphone, and (ii) the vehicular Bluetooth transceiver of said vehicle; and (II) determination by a Global Positioning System (GPS) unit of said smartphone, that said smartphone, which is currently paired via Bluetooth to said vehicle, is located away from a parking spot that was originally associated with said paid parking session of said vehicle; and (III) a received user-confirmation of an autonomous proposal of said parking-termination determination unit to terminate said paid parking session based on identified Bluetooth pairing between said smartphone and said vehicle.

In some embodiments, the method comprises: at said wireless communication transceiver, receiving a message indicating an automatically-generated parking bill, which corresponds to paid parking of said vehicle during a parking time-slot that: (i) begins at the time of sending said first wireless communication signal, and (ii) ends at the time of sending said second wireless communication signal indicating autonomous termination of the paid parking session by said smartphone; wherein said parking bill is generated by further taking into account a particular parking tariff of parking at a municipal region in which said vehicle was located during said paid parking session, based on a wireless communication signal received from said smartphone and indicating the location of said vehicle at commencement of said paid parking session as determined by a Global Positioning System (GPS) unit of said smartphone.

In some embodiments, the method comprises: at said wireless communication transceiver is transceiver, receiving a message indicating an automatically-generated estimate of monetary saving amount; conveying to said user a monetary amount that said user saved due to the autonomous termination of the paid parking session by said smartphone.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components or elements that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

1. A vehicular parking system, comprising:
a parking server comprising:
(a) a wireless communication transceiver to receive a first wireless communication signal, indicating that a user of a vehicle that is associated with a smartphone has commenced a paid parking session,
(b) a parking session commencement unit that, in response to said first wireless communication signal, updates a parking record in said vehicular parking system, to indicate that said vehicle is associated with said paid parking session;
(c) wherein said wireless communication transceiver, subsequently, is to receive a second wireless communication signal, indicating that said smartphone has autonomously determined to end said paid parking session, based on an autonomous analysis of said smartphone and not based on a manual user-command to end the paid parking session;
(d) a parking session termination unit that, in response to said second wireless communication signal, updates said parking record in said vehicular parking system, to indicate that said vehicle is no longer associated with any paid parking session.

2. The system of claim 1, wherein said second wireless communication signal is received based on an autonomous determination of said smartphone that is based at least on identification of Bluetooth pairing between: (i) a Bluetooth transceiver of said smartphone, and (ii) a Bluetooth transceiver of said vehicle.

3. The system of claim 1, wherein said second wireless communication signal is received based on an autonomous determination of said smartphone that is based at least on:
(I) identification of Bluetooth pairing between: (i) a Bluetooth transceiver of said smartphone, and (ii) a Bluetooth transceiver of said vehicle;
and
(II) determination by a Global Positioning System (GPS) unit of said smartphone, that said smartphone, which is currently paired via Bluetooth to said vehicle, is located away from a parking spot that was originally associated with said paid parking session of said vehicle.

4. The system of claim 1, wherein said second wireless communication signal is received based on an autonomous determination of said smartphone that is based on, at least, an aggregated combination of:
(I) identification of Bluetooth pairing between: (i) a Bluetooth transceiver of said smartphone, and (ii) a Bluetooth transceiver of said vehicle;
and
(II) determination by a Global Positioning System (GPS) unit of said smartphone, that said smartphone, which is currently paired via Bluetooth to said vehicle, is located away from a parking spot that was originally associated with said paid parking session of said vehicle;
and
(III) a wireless communication signal received from said smartphone, indicating that said user has provided a manual user-confirmation to an autonomous proposal of said smartphone to terminate said paid parking session based on identified Bluetooth pairing between said smartphone and said vehicle.

5. The system of claim 1, wherein the parking server comprises:
an automated billing unit to generate a parking bill, which corresponds to paid parking of said vehicle during a parking time-slot that: (i) begins at the time of receiving said first wireless communication signal, and (ii) ends at the time of receiving said second wireless communication signal indicating autonomous termination of the paid parking session by said smartphone;
wherein the automated billing unit is to generate said parking bill by further taking into account a particular parking tariff of parking at a municipal region in which said vehicle was located during said paid parking session, based on a wireless communication signal received from said smartphone and indicating the location of said vehicle at commencement of said paid parking session as determined by a Global Positioning System (GPS) unit of said smartphone.

6. The system of claim 1, wherein the parking server comprises:
a parking fee saving estimator, to estimate a monetary saving amount indicating to said user a monetary amount that said user saved due to the autonomous termination of the paid parking session by said smartphone of the user;
wherein the parking fee saving estimator is to determine: (i) a maximum allowed parking time that is allowed for a paid parking session at a particular location in which said vehicle parked during said paid parking session; (ii) an actual parking time of said paid parking session that was terminated based on autonomous determination of said smartphone; (iii) a difference between said maximum allowed parking time and said actual parking time; (iv) a product of multiplying said difference of step (iii), by a parking tariff that is associated with said particular location;
wherein said wireless communication transceiver is to wirelessly transmit to said smartphone of said user, at least one of: (I) a wireless communication signal that triggers said smartphone to display to the user a message indicating said monetary saving amount; (II) a Short Message Service (SMS) message indicating said monetary saving amount.

7. A smartphone comprising:
a Bluetooth transceiver to perform Bluetooth pairing with a vehicular Bluetooth transceiver of a vehicle;
a wireless communication transceiver to wirelessly send to a parking server, a first wireless communication signal indicating that a user of said vehicle that is associated with said smartphone has commenced a paid parking session;
a parking-termination determination unit, to autonomously determine to terminate said paid parking session of said vehicle, based on an autonomous analysis by the parking-termination determination unit of said smartphone and not based on a manual user-command to end the paid parking session;
wherein said wireless communication transceiver is to wirelessly send to said parking server, based on a signal from said parking-termination determination unit, a second wireless communication signal indicating that said smartphone has autonomously determined to end said paid parking session.

8. The smartphone of claim 7,
wherein said parking-termination determination unit is to autonomously determine to terminate said paid parking session of said vehicle based at least on identification of Bluetooth pairing between: (i) the Bluetooth transceiver of said smartphone, and (ii) the vehicular Bluetooth transceiver of said vehicle.

9. The smartphone of claim 7,
wherein said parking-termination determination unit is to autonomously determine to terminate said paid parking session of said vehicle based at least on:
(I) identification of Bluetooth pairing between: (i) the Bluetooth transceiver of said smartphone, and (ii) the vehicular Bluetooth transceiver of said vehicle;
and
(II) determination by a Global Positioning System (GPS) unit of said smartphone, that said smartphone, which is currently paired via Bluetooth to said vehicle, is located away from a parking spot that was originally associated with said paid parking session of said vehicle.

10. The smartphone of claim 7,
wherein said parking-termination determination unit is to autonomously determine to terminate said paid parking session of said vehicle based on:
(I) identification of Bluetooth pairing between: (i) the Bluetooth transceiver of said smartphone, and (ii) the vehicular Bluetooth transceiver of said vehicle;
and
(II) a received user-confirmation of an autonomous proposal of said parking-termination determination unit to terminate said paid parking session based on identified Bluetooth pairing between said smartphone and said vehicle.

11. The smartphone of claim 7,
wherein said parking-termination determination unit is to autonomously determine to terminate said paid parking session of said vehicle based on:
(I) identification of Bluetooth pairing between: (i) the Bluetooth transceiver of said smartphone, and (ii) the vehicular Bluetooth transceiver of said vehicle;
and
(II) determination by a Global Positioning System (GPS) unit of said smartphone, that said smartphone, which is currently paired via Bluetooth to said vehicle, is located away from a parking spot that was originally associated with said paid parking session of said vehicle;
and
(III) a received user-confirmation of an autonomous proposal of said parking-termination determination unit to terminate said paid parking session based on identified Bluetooth pairing between said smartphone and said vehicle.

12. The smartphone of claim 7,
wherein the wireless communication transceiver is to receive a message indicating an automatically-generated parking bill, which corresponds to paid parking of said vehicle during a parking time-slot that: (i) begins at the time of sending said first wireless communication signal, and (ii) ends at the time of sending said second wireless communication signal indicating autonomous termination of the paid parking session by said smartphone;
wherein said parking bill is generated by further taking into account a particular parking tariff of parking at a municipal region in which said vehicle was located during said paid parking session, based on a wireless communication signal received from said smartphone and indicating the location of said vehicle at commencement of said paid parking session as determined by a Global Positioning System (GPS) unit of said smartphone.

13. The smartphone of claim 7,
wherein the wireless communication transceiver is to receive a message indicating an automatically-generated estimate of monetary saving amount, and to convey to said user a monetary amount that said user saved due to the autonomous termination of the paid parking session by said smartphone;
wherein the automatically-generated estimate of monetary saving amount is determined based on: (i) a maximum allowed parking time that is allowed for a paid parking session at a particular location in which said vehicle parked during said paid parking session; (ii) an actual parking time of said paid parking session that was terminated based on autonomous determination of said smartphone; (iii) a difference between said maximum allowed parking time and said actual parking time; (iv) a product of multiplying said difference of step (iii), by a parking tariff that is associated with said particular location.

14. A method comprising:
(a) at a vehicular parking server, receiving a first wireless communication signal, indicating that a user of a vehicle that is associated with a smartphone has commenced a paid parking session,
(b) at a parking session commencement unit of said vehicular parking server, in response to said first wireless communication signal, updating a parking record in said vehicular parking system, to indicate that said vehicle is associated with said paid parking session;
(c) at said vehicular parking server, subsequently, receiving a second wireless communication signal, indicating that said smartphone has autonomously determined to end said paid parking session, based on an autonomous analysis of said smartphone and not based on a manual user-command to end the paid parking session;
(d) at a parking session termination unit of said vehicular parking server, in response to said second wireless communication signal, updating said parking record in said vehicular parking system, to indicate that said vehicle is no longer associated with any paid parking session;
wherein said second wireless signal is received based on an autonomous determination of said smartphone that is based at least on identification of Bluetooth pairing between: (i) a Bluetooth transceiver of said smartphone, and (ii) a Bluetooth transceiver of said vehicle;
wherein said method is executable by a vehicular parking system which comprises at least a hardware processor.

15. The method of claim 14, wherein said second wireless communication signal is received based on an autonomous determination of said smartphone that is based at least on:
(I) identification of Bluetooth pairing between: (i) a Bluetooth transceiver of said smartphone, and (ii) a Bluetooth transceiver of said vehicle;
and
(II) determination by a Global Positioning System (GPS) unit of said smartphone, that said smartphone, which is currently paired via Bluetooth to said vehicle, is located away from a parking spot that was originally associated with said paid parking session of said vehicle.

16. The method of claim 14, wherein said second wireless communication signal is received based on an autonomous determination of said smartphone that is based on:
(I) identification of Bluetooth pairing between: (i) a Bluetooth transceiver of said smartphone, and (ii) a Bluetooth transceiver of said vehicle;
and
(II) a wireless communication signal received from said smartphone, indicating that said user has provided a manual user-confirmation to an autonomous proposal of said smartphone to terminate said paid parking session based on identified Bluetooth pairing between said smartphone and said vehicle.

17. The method of claim 14, wherein said second wireless communication signal is received based on an autonomous determination of said smartphone that is based on, at least, an aggregated combination of:
(I) identification of Bluetooth pairing between: (i) a Bluetooth transceiver of said smartphone, and (ii) a Bluetooth transceiver of said vehicle;
and
(II) determination by a Global Positioning System (GPS) unit of said smartphone, that said smartphone, which is currently paired via Bluetooth to said vehicle, is located away from a parking spot that was originally associated with said paid parking session of said vehicle;
and
(III) a wireless communication signal received from said smartphone, indicating that said user has provided a manual user-confirmation to an autonomous proposal of said smartphone to terminate said paid parking session based on identified Bluetooth pairing between said smartphone and said vehicle.

18. The method of claim 14, further comprising:
automatically generating a parking bill, which corresponds to paid parking of said vehicle during a parking time-slot that: (i) begins at the time of receiving said first wireless communication signal, and (ii) ends at the time of receiving said second wireless communication signal indicating autonomous termination of the paid parking session by said smartphone;
wherein said parking bill is automatically generated by further taking into account a particular parking tariff of parking at a municipal region in which said vehicle was located during said paid parking session, based on a wireless communication signal received from said smartphone and indicating the location of said vehicle at commencement of said paid parking session as determined by a Global Positioning System (GPS) unit of said smartphone.

19. The method of claim 14, further comprising:
automatically determining a monetary saving amount that indicates to said user a monetary amount that said user saved due to the autonomous termination of the paid parking session by said smartphone of the user;
wherein said determining of the monetary saving amount is performed based on determining: (i) a maximum allowed parking time that is allowed for a paid parking session at a particular location in which said vehicle parked during said paid parking session; (ii) an actual parking time of said paid parking session that was terminated based on autonomous determination of said smartphone; (iii) a difference between said maximum allowed parking time and said actual parking time; (iv) a product of multiplying said difference of step (iii), by a parking tariff that is associated with said particular location.

20. The method of claim 14, further comprising:
automatically determining a monetary saving amount that indicates to said user a monetary amount that said user saved due to the autonomous termination of the paid parking session by said smartphone of the user;
wherein said determining of the monetary saving amount is performed based on determining: (i) a maximum allowed parking time that is allowed for a paid parking session at a particular location in which said vehicle parked during said paid parking session; (ii) an actual parking time of said paid parking session that was terminated based on autonomous determination of said smartphone; (iii) a difference between said maximum allowed parking time and said actual parking time; (iv) a product of multiplying said difference of step (iii), by a parking tariff that is associated with said particular location;
wirelessly transmitting to said smartphone of said user, at least one of: (I) a wireless communication signal that triggers said smartphone to display to the user a message indicating said monetary saving amount; (II) a Short Message Service (SMS) message indicating said monetary saving amount.
